(19) United States
(12) Patent Application Publication
(10) Pub. No.: US 2008/0237549 A1
(43) Pub. Date: Oct. 2, 2008

(54) PHOSPHOR MATERIAL AND MANUFACTURING METHOD THEREOF

(75) Inventors: Yasuo NAKAMURA, Tokyo (JP); Takahiro KAWAKAMI, Isehara (JP); Rie MATSUBARA, Isehara (JP); Makoto HOSOBA, Atsugi-shi (JP)

Correspondence Address: NIXON PEABODY, LLP, 401 9TH STREET, NW, SUITE 900, WASHINGTON, DC, 20004-2128, US

(73) Assignee: SEMICONDUCTOR ENERGY LABORATORY CO., LTD., Atsugi-shi (JP)

(21) Appl. No.: 12/054,144

(22) Filed: Mar. 24, 2008

(30) Foreign Application Priority Data
Mar. 26, 2007 (JP) 2007-080203

(51) Int. Cl. H01B 1/02

(52) U.S. Cl. 252/519.4; 252/500; 252/519.5; 252/521.2; 252/520.1; 252/520.2; 252/520.5; 252/518.1; 252/520.4

(57) ABSTRACT

A novel phosphor material which can be manufactured without utilizing a fault formation process which is difficult to be controlled. The phosphor material has a eutectic structure formed of a base material that is a semiconductor formed of a Group 2 element and a Group 6 element, a semiconductor formed of a Group 3 element and a Group 5 element, or a ternary phosphor formed of an alkaline earth metal, a Group 3 element, and a Group 6 element, and a solid solution material including a transition metal. The phosphor material is suited for an EL element because of less variation of characteristic since defect formation process in which stress is applied externally to form a defect inside of a phosphor material is not needed.

### BACKGROUND OF THE INVENTION

1. Field of the Invention

The present invention relates to a novel phosphor material and a manufacturing method thereof, and also relates to a light-emitting element (an EL element) using the phosphor material, and a light-emitting device and an electronic apparatus each having the EL element.

2. Description of the Related Art

Self-luminous type displays having an element utilizing a phenomenon in which a material emits light by application of an electric field, that is, an electroluminescence (hereinafter, also referred to as EL) element have been researched and partially put into practical use. As for such a display, the following can be given as one feature: the thickness of a manufactured display can be thin because of no need for a backlight unlike a liquid crystal display, which is advantageous for power consumption. Note that the EL element has been widely used in various fields as well as for a display, such as for a dial face of a clock, a membrane switch, or an electric spectacular display.

EL elements are classified depending on whether the luminescence material is an organic compound or an inorganic compound; and generally, the former is called an organic EL element and the latter is called an inorganic EL element. Further, inorganic EL elements are classified into a dispersion type and a thin-film type depending on the element structure. Further, as driving systems of inorganic EL elements, there are a DC drive type and an AC drive type. Note that, as for the luminescence mechanism, there are donor-acceptor recombination-type luminescence which utilizes a donor level and an acceptor level, and localized-type luminescence which utilizes inner-shell electron transition of metal ions.

A dispersion type inorganic EL element is superior in that a surface-emitting element can be manufactured at a low cost by a simple method such as a screen printing method or a coating method, though the luminance is low. On the other hand, a thin-film type inorganic EL element has features of high luminance and long life.

Further, a phosphor of ZnS:CuCl is used as a phosphor material of the dispersion type inorganic EL element, and the Fischer model is advocated as a model of explaining the luminescent mechanism. Fischer found out that there is a starting structure of luminescence at a grain boundary inside of the phosphor of ZnS:CuCl. He considered that exchange of electric charges occurs between the phosphor of ZnS:CuCl and the structure by application of an electric field to the structure, and after that, the electric charges are recombined in accordance with inversion of an AC voltage, which leads to luminescence.

Fischer guessed that the structure is formed of a highly conductive material since the electric field is concentrated on the structure, and the material is precipitated copper sulfide. That is, it can be said that a Cu impurity added into ZnS functions not only for forming a luminescence level but also as a supply source of Cu for forming a Fischer structure in crystals.

However, it is considered that, for manufacturing a phosphor which emits EL more strongly, it is insufficient only to add a Cu impurity (e.g., a copper compound such as copper sulfate) into a ZnS phosphor and bake them.

The Fischer structure is generated in a defect inside of crystals, and therefore, it is necessary to form a defect in a phosphor in advance. As a method for forming a defect, a method in which stress is applied from outside a phosphor to form a defect inside of the phosphor is known (see Reference 1: Japanese Published Patent Application No. Hei06-330035 and Reference 2: Japanese Published Patent Application No. Hei11-193378).

### SUMMARY OF THE INVENTION

However, in the method in which stress is applied from outside a phosphor to form a defect inside of the phosphor, the defect is not generated if the intensity of the stress applied to a ZnS phosphor is too low, whereas crystals are broken or the number of defects becomes too large if the intensity is too high. If too much defects exist, the emission efficiency of a phosphor degrades so that a good phosphor as an inorganic EL material cannot be obtained.

Furthermore, since a defect is formed inside of crystals by application of stress from outside according to the method as described above, it is difficult to control the number and size of defects as appropriate, which causes variation in quality.

In view of the foregoing, it is an object of the present invention to provide a novel phosphor material which can be synthesized without utilizing a defect formation process which is difficult to be controlled, and a manufacturing method thereof.

In view of the foregoing, the present inventors have considered that, as for a phosphor material, an unstable process such as a defect formation process by application stress or the like is not required if a structure in which a material which exchanges electric charges through a boundary between the material and a phosphor with external voltage is jointed to the phosphor can be formed directly without using crystalline defects. Thus, the present inventors have found that an eutectic structure (hereinafter referred to as a composite structure) of a base material which emits fluorescence and either a semiconductor formed of a Group 2 element and a Group 6 element of the Periodic Table or a conductive material can be manufactured and the eutectic structure has a function as a phosphor of an inorganic EL material.

The base material used in the present invention can be selected depending on a luminescence color. The following can be given as examples thereof; (1) semiconductor which is formed of a Group 2 element and a Group 6 element, (2) semiconductor which is formed of a Group 3 element and a Group 5 element, (3) ternary material (ternary phosphor) which is formed of an alkaline earth metal, a Group 3 element, and a Group 6 element, (4) oxide semiconductor, (5) alloy crystal of the above, and the like.

As examples of the (1) semiconductor which is formed of a Group 2 element and a Group 6 element or the (2) semiconductor which is formed of a Group 3 element and a Group 5 element, the following can be given; cadmium sulfide (CdS), cadmium selenide (CdSe), cadmium telluride (CdTe), zinc sulfide (ZnS), zinc selenide (ZnSe), zinc telluride (ZnTe), calcium sulfide (CaS), magnesium sulfide (MgS), strontium sulfide (SrS), gallium phosphide (GaP), gallium arsenide (GaAs), and the like.

Further, as examples of the (3) ternary material (ternary phosphor) which is formed of an alkaline earth metal, a Group 3 element, and a Group 6 element, the following can be given; barium thioaluminate (BaAl₂S₄), calcium thiogallate (CaGa₂S₄), zinc silicate (Zn₂SiO₄), Zn₂GaO₄, zinc gallate (ZnGa₂O₄), ZnGeO₃, ZnGeO₄, zinc aluminate (ZnAl₂O₄), calcium gallate (CaGa₂O₄), CaGeO₃, Ca₂Ge₂O₇, strontium aluminate (SrAl₂O₄), strontium gallate (SrGa₂O₄), SrP₂O₇, magnesium gallate (MgGa₂O₄), Mg₂GeO₄, MgGeO₃, barium aluminate (BaAl₂O₄), Ga₂Ge₂O₇, beryllium gallate (BeGa₂O₄), yttrium silicate (Y₂SiO₅), Y₂GeO₅, Y₂Ge₂O₇, Y₄GeO₈, Y₂O₂S, and the like.

As examples of the (4) oxide semiconductor, the following can be given; calcium oxide (CaO), gallium oxide (Ga₂O₃), germanium dioxide (GeO₂), yttrium oxide (Y₂O₃), tin oxide (SnO₂), and the like.

Further, into such a base material, any of transition metals such as manganese (Mn), copper (Cu), chromium (Cr), rare earthes, and the like can be added, or ions for forming D (donor)-A (acceptor) pairs can be added. The transition metal or the like also has a function as a luminescence center with localized-type luminescence.

As the conductive material, there is a material formed of a good conductor or a semiconductor, and it is necessary to, with the base material, form a eutectic crystal, preferably without forming a solid solution. On the basis of them, the conductive material can be selected in combination with the base material. For example, a metal oxide can be given as typical example of the conductive material. The metal oxide exhibits conductive properties by introduction of an oxygen vacancy or a defect, or addition of a dopant impurity.

As examples of the metal oxide, the following can be given; zinc oxide (ZnO), nickel oxide (NiO), tin oxide (SnO₂), titanium oxide (TiO₂), cobalt trioxide (CoO₃), cobalt oxide (CoO), tungsten oxide (WO₃), molybdenum oxide (MoO₃), vanadium trioxide (V₂O₃), vanadium pentoxide (V₂O₅), indium tin oxide (ITO), indium oxide (In₂O₃), rhenium trioxide (ReO₃), ruthenium oxide (RuO₂), strontium ruthenium oxide (SrRuO₃), strontium iridium oxide (SrIrO₃), barium lead oxide (BaPbO₃), and the like. Such a metal oxide may lack oxygen atoms or metal atoms, have excessive oxygen atoms, or be nonstoichiometric, because there is a case where the conductivity is increased due to deviation of an oxygen atom from stoichiometric composition.

An additive may be used in order to control the conductivity of a phosphor, or characteristics or the sintering state of a junction interface. For example, as the additive, a manganese compound, a cobalt compound, a bismuth compound, a chromium compound, an aluminum compound, or a gallium compound can be given in addition to halide such as sodium chloride, magnesium chloride, or barium chloride. The additive may be added in the form of oxide or a material which is decomposed into metal or oxide by baking, though it may be added in the form of metal as well. Compared with the case of adding in the form of metal, mixing of an excessive unreacted metal ion into a phosphor can be prevented to form a solid solution. Note that each of manganese (Mn) and chromium (Cr) may also have a function as a luminescence center material.

The base material and the conductive material are jointed to each other by baking and form a eutectic structure (composite structure). Baking temperature is selected depending on the sintering temperature of the base material; and it is in the range from 800° C. to 1500° C.

For example, as a procedure for forming a eutectic structure using a base material, a conductive material, and a transition metal, there are (1) procedure for forming a eutectic structure in which a material is prepared by mixing a conductive material and a transition metal and prebaking, and a base material is added into the material and baking is performed thereon, (2) procedure for forming a eutectic structure in which a material is prepared by mixing a base material and a transition metal and prebaking, and a conductive material is added into the material, and (3) procedure for forming a eutectic structure in which a conductive material, a transition metal, and a base material are mixed at the same time.

The above-described transition metal also has a function as an additive, is mixed in the base material to form a solid solution, and also has a function as a luminescence center.

A phosphor thus formed has a eutectic structure in which a conductive material is taken into a base material that is a semiconductor which is formed of a Group 2 element and a Group 6 element, a semiconductor which is formed of a Group 3 element and a Group 5 element, a ternary phosphor which is formed of an alkaline earth metal, a Group 3 element, and a Group 6 element, an oxide semiconductor, or a mixed crystal of the above. That is, the phosphor has the cutectic structure in which the base material and the conductive material are segregated from each other. In other words, the phosphor has the eutectic structure in which the conductive material is segregated in the base material. Further, in the case of adding a localized-type luminescence center, as a phosphor, the phosphor has a eutectic structure in which the luminescence center is mixed in the base material.

Specific structures of the present invention will he described hereinafter.

One aspect of the present invention is a phosphor material having a eutectic structure of a base material that is a semiconductor which is formed of a Group 2 element and a Group 6 element, a semiconductor which is formed of a Group 3 element and a Group 5 element, an alkaline earth metal, or a ternary material which is formed of a Group 3 element or a Group 6 element and a solid solution material of a solid solution of a semiconductor which is formed of a Group 2 clement and a Group 6 element and a transition metal.

One aspect of the present invention is a phosphor material having a eutectic structure of a base material that is a semiconductor which is formed of a Group 2 element and a Group 6 element, a semiconductor which is formed of a Group 3 element and a Group 5 element, an alkaline earth metal, or a ternary material which is formed of a Group 3 element or a Group 6 element and a solid solution material of a solid solution of a conductive material and a transition metal.

In the present invention, the solid solution material is agglomerated in the base material. That is, in the present invention, the base material and the solid solution material are segregated from each other.

In the present invention, the solid solution material includes the transition metal in the range of 0.01 mol % to 100 mol % both inclusive with respect to the base material. Note that, when the concentration of the transition metal is 100 mol % with respect to the base material, transition metal:base material=1:1 is satisfied. The transition metal which can also has a function as a luminescence center can improve the luminescence intensity when the large amount of the transition metal can be contained.

In the present invention, the molar ratio of the solid solution material to the base material (solid solution material/base material) is in the range of 0.1 to 100 both inclusive, and is preferably in the range of 0.3 to 3 both inclusive.

In the present invention, a grain diameter of the solid solution material is smaller than that of the base material. Preferably, the grain diameter of the solid solution material is equal to or less than ½ of that of the base material. Specifically, the grain diameter of the base material is in the range of 0.1 μm to 10 μm both inclusive and the grain diameter of either the semiconductor formed of a Group 2 element and a Group 6 element or the conductive material is in the range of 0.01 μm to 1 μm both inclusive; it is preferable to decrease the grain diameter of either the semiconductor formed of a Group 2 element and a Group 6 element or the conductive material in accordance with the increase in the grain diameter of the base material. This is because a eutectic structure can be obtained more easily.

In the present invention, either a semiconductor formed of a Group 2 element and a Group 6 element or a conductive material and a transition metal are mixed with each other and baked, and then, a base material that is a semiconductor which is formed of a Group 2 element and a Group 6 element, a semiconductor which is formed of a Group 3 element and a Group 5 element, an alkaline earth metal, or a ternary material which is formed of a Group 3 element or a Group 6 element is added thereto and baking is performed thereon so that a eutectic structure is formed. By mixing either the semiconductor formed of a Group 2 element and a Group 6 element or the conductive material and the transition metal with each other, a solid solution material can be formed.

In the present invention, a base material that is a semiconductor which is formed of a Group 2 element and a Group 6 element, a semiconductor which is formed of a Group 3 element and a Group 5 element, an alkaline earth metal, or a ternary material which is formed of a Group 3 element or a Group 6 element and a transition metal are mixed with each other and baked, and then, either a semiconductor formed of a Group 2 element and a Group 6 element or a conductive material is added thereto and baking is performed thereon so that a eutectic structure is formed. By mixing either the semiconductor formed of a Group 2 element and a Group 6 element or the conductive material and the transition metal with each other, a solid solution material can be formed.

In the present invention, either a semiconductor formed of a Group 2 element and a Group 6 element or a conductive material, a base material that is a semiconductor which is formed of a Group 2 element and a Group 6 element, a semiconductor which is formed of a Group 3 element and a Group 5 element, an alkaline earth metal, or a ternary material which is formed of a Group 3 element or a Group 6 element, and a transition metal are mixed and baked so that a eutectic structure is formed. By mixing either the semiconductor formed of a Group 2 element and a Group 6 element or the conductive material and the transition metal with each other, a solid solution material can be formed.

In the present invention, a grain diameter of either the semiconductor formed of a Group 2 element and a Group 6 element or the conductive material which is mixed to form a solid solution material is in the range of 0.01 μm to 1 μm both inclusive. The smaller the grain diameter of either the semiconductor formed of a Group 2 element and a Group 6 element or the conductive material to form a solid solution material is, the more easily the solid solution material is formed and a eutectic structure is also formed. Further, for accomplishing an effect of the present invention, it is preferable that the grain diameter of either the semiconductor formed of a Group 2 element and a Group 6 element or the conductive material to form a solid solution material be equal to or less than ½ of that of the base material.

In the present invention, in forming a solid solution material or in forming a eutectic structure, it is preferable that a mixture to be processed be baked after it is pelletized. This is because the solid solution material or the eutectic structure can be obtained more easily.

With the phosphor material of the present invention, inorganic EL elements having less variation of characteristic can be manufactured since defect formation process in which stress is applied externally to form a defect inside of a phosphor material is not needed. Further, in an inorganic EL element including the phosphor material of the present invention, the number and size of junctions which contribute to electroluminescence (EL) can be easily controlled.

Further, with the inorganic EL material of the present invention, a dispersion-type inorganic EL element with localized-type luminescence, which has not been able to be manufactured, can be manufactured.

Furthermore, the inorganic EL element of the present invention can be applied to not only an EL element of an AC drive but also an EL element of a DC drive.

### BRIEF DESCRIPTION OF THE DRAWINGS

FIG. 1 is a cross-sectional diagram showing a structure of an EL element in Embodiment 1.

FIG. 2 is a cross-sectional diagram showing a structure of an EL element in Embodiment 1.

FIG. 3 is a graph of EL properties using an EL element in Embodiment 1.

FIG. 4 is a graph of EL properties using an EL element in Embodiment 1.

FIG. 5 is a SIM image of a phosphor material in Embodiment 2.

FIG. 6 is a SIM image and graphs of EDX results of a phosphor material in Embodiment 2.

FIG. 7 is a graph of EL properties using an EL element in Embodiment 2.

FIG. 8 is a graph of EL properties using an EL element in Embodiment 3.

FIG. 9 is a diagram showing a light-emitting device in an embodiment mode.

FIG. 10 is a diagram showing a light-emitting device in an embodiment mode.

FIG. 11 is a diagram showing a light-emitting device in an embodiment mode.

FIGS. 12A and 12B are diagrams showing a light-emitting device in an embodiment mode.

FIGS. 13A and 13B are diagrams showing a light-emitting device in an embodiment mode.

FIGS. 14A and 14B are diagrams showing a light-emitting device in an embodiment mode.

FIGS. 15A to 15D are diagrams illustrating electronic apparatuses in an embodiment mode.

FIG. 16 is a diagram illustrating an electronic apparatus in an embodiment mode.

FIG. 17 shows an image of TEM and a result of EDX of a phosphor material in Embodiment 2.

FIG. 18 is a graph of EL properties using an EL element in Embodiment 4.

FIG. 19 is a graph of EL properties using an EL element in Embodiment 5.

FIG. 20 is a graph of EL properties using an EL element in Embodiment 6.

FIG. 21 is a graph of EL properties using an EL element in Embodiment 7.

FIG. 22 is a graph of EL properties using an EL element in Embodiment 8.

FIG. 23 is a graph of EL properties using an EL element in Embodiment 9.

FIG. 24 is a graph of EL properties using an EL element in Embodiment 10.

FIG. 25 is a graph of EL properties using an EL element in Embodiment 11.

FIG. 26 is a graph of EL properties using an EL element in Embodiment 12.

### DETAILED DESCRIPTION OF THE INVENTION

Although the present invention will be fully described by way of embodiment modes and embodiments with reference to the accompanying drawings, it is to be understood that various changes and modifications will be apparent to those skilled in the art. Therefore, unless such changes and modifications depart from the scope of the invention, they should be construed as being included therein. Note that the same reference numerals are used to denote the same portions or portions having similar functions throughout the drawings for describing the embodiment modes and embodiments, and the description thereof is not repeated.

### Embodiment Mode 1

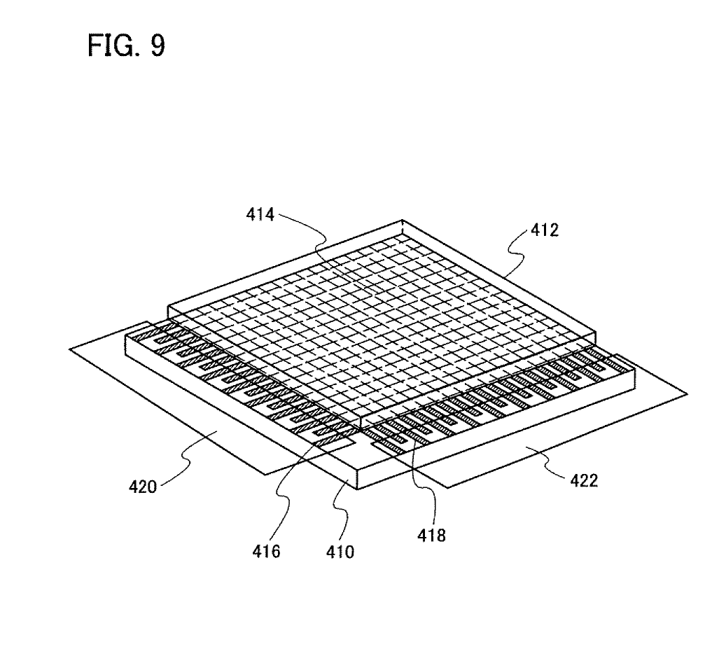

In this embodiment mode, a light-emitting device formed of EL elements having the phosphor material of the present invention is described using FIGS. 9, 10, 11, 12A and 12B, and 13A and 13B.

FIG. 9 is a structure diagram of a main portion of a display device. First electrodes 416 and second electrodes 418 which extend in a direction intersecting the first electrodes 416 are provided over a substrate 410. An EL element is formed by providing a light-emitting layer having the phosphor material of the present invention at each intersection between the first electrodes 416 and the second electrodes 418. As for the structure of an EL element, an AC drive EL element can be formed when a dielectric layer is formed over the first electrode 416. On the other hand, the dielectric layer does not need to be provided when a DC drive EL element is formed. Further, as for the light-emitting layer, a stacked-layer structure of a p-type semiconductor and an n-type semiconductor may be employed. Furthermore, another layer can be provided in addition to the light-emitting layer. For example, under the light-emitting layer, any of a layer for improving the orientation of the light-emitting layer or a layer which has functions like an injection layer or a transport layer may be provided.

In the display device shown in FIG. 9, a plurality of the first electrodes 416 and the second electrodes 418 are disposed and the EL elements are arranged in matrix to form a display portion 414. The potentials of the first electrode 416 and the second electrode 418 are controlled based on a signal for displaying an image, to control emission/non-emission of each EL element, whereby moving or still images can be displayed on the display portion 414. Such a display device is a simple matrix display device which is driven by signals supplied from an external circuit. Such a simple matrix display device has a simple structure; therefore, it can be easily manufactured even when the display area is increased.

When both of the first electrode 416 and the second electrode 418 are formed of transparent conductive films, a dual emission light-emitting device can be completed. On the other hand, when one of the first electrode 416 and the second electrode 418 is formed of a reflective conductive film and the other is formed of a transparent conductive film, a single-sided emission light-emitting device can be completed.

As a material for such a transparent conductive film, any of the following can be used: indium tin oxide (ITO), indium tin oxide containing silicon oxide (ITSO), indium zinc oxide (IZO), indium oxide containing tungsten oxide and silicon oxide (IWZO), and the like. As a material for such a reflective conductive film, any of the following can be used: aluminum (Al), silver (Ag), gold (Au), platinum (Pt), nickel (Ni), tungsten (W), chromium (Cr), molybdenum (Mo), iron (Fe), cobalt (Co), copper (Cu), palladium (Pd), nitride of a metal material (e.g., titanium nitride), and the like.

Note that an opposed substrate 412 may be provided as required; sealing may be performed by a protective material formed at a position aligned with the display portion 414 as well. The protective material is not a plate-form hard material, but is formed of a resin film or a resin material.

The first electrodes 416 and the second electrodes 418 are led out to the edge of the substrate 410, and form terminals connected to the external circuit. That is, the first electrodes 416 and the second electrodes 418 are connected to first and second flexible wiring substrates 420 and 422 respectively in the edge of the substrate 410. The external circuit includes in its category a controller circuit for controlling a video signal, a power supply circuit, a tuner circuit, and the like.

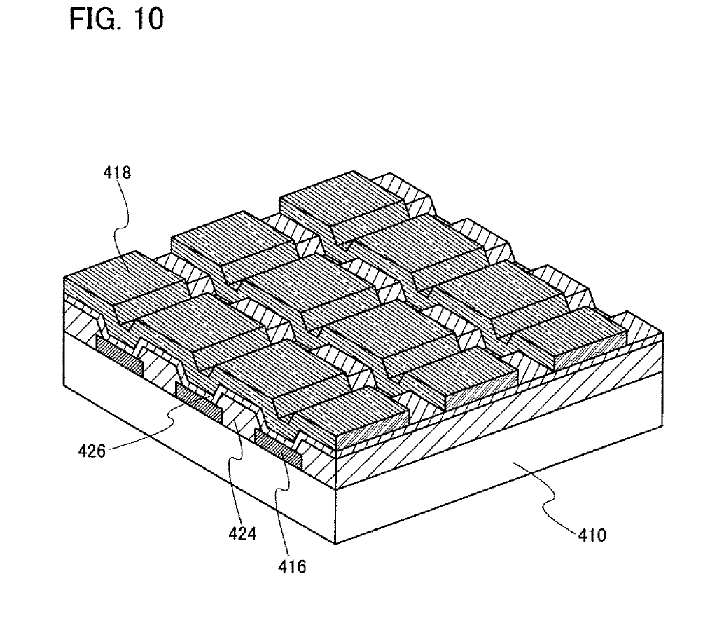

FIG. 10 is a partial enlarged diagram of the structure of the display portion 414 in FIG. 9. Bank layers 424 are formed on edges of each first electrode 416 formed over the substrate 410. Further, a light-emitting layer (also called an EL layer) 426 is formed over an exposed surface which is not covered with the bank layer, of the first electrode 416. The second electrodes 418 are formed over the EL layer 426 so as to intersect the first electrodes 416. That is, the second electrodes 418 are extended and provided so as to run on the bank layers 424. Each bank layer 424 is formed of an insulating material so as to prevent short circuit between the first electrode 416 and the second electrode 418. The edge of each bank layer 424 slopes, that is, a so-called tapered shape is provided, so that a portion of the bank layer 424 which covers the edge of the first electrode 416 does not have a steep step. By formation of each bank layer 424 to have such a shape, the bank layers 424 can adequately cover the first electrodes 416, whereby defects such as cracks and breaking can be prevented.

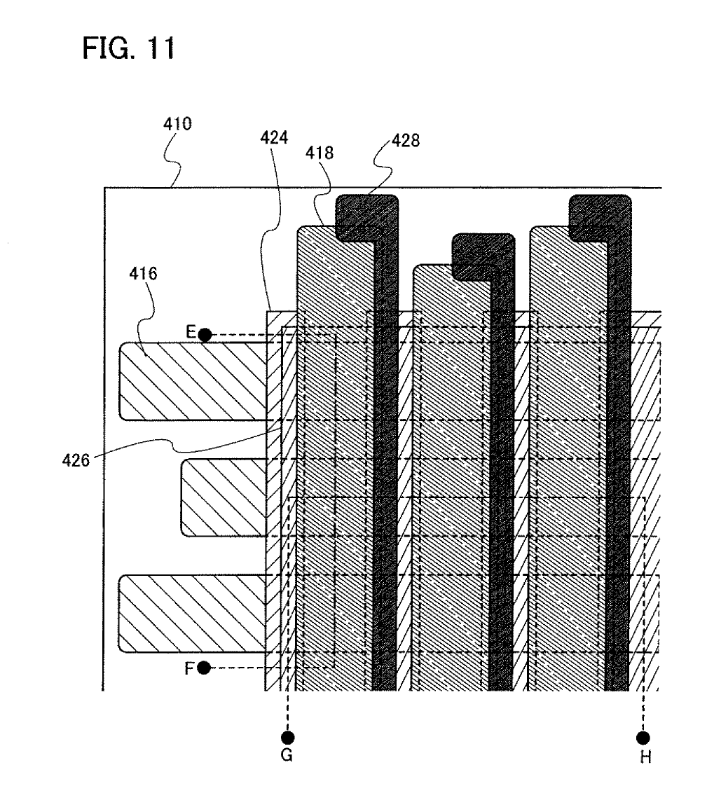

FIG. 11 is a plan diagram of the display portion 414 in FIG. 10, which shows the arrangement of the first electrodes 416, the second electrodes 418, the bank layers 424, and the EL layer 426 over the substrate 410. It is preferable to provide auxiliary electrodes 428 in order to reduce potential loss due to resistance when each of the second electrodes 418 is formed of a transparent conductive film of indium tin oxide, zinc oxide, or the like. In this case, each auxiliary electrode 428 is preferably formed of a high-melting-point metal such as titanium, tungsten, chromium, or tantalum, or of a combination of such a high-melting-point metal and a low-resistance metal such as aluminum or silver.

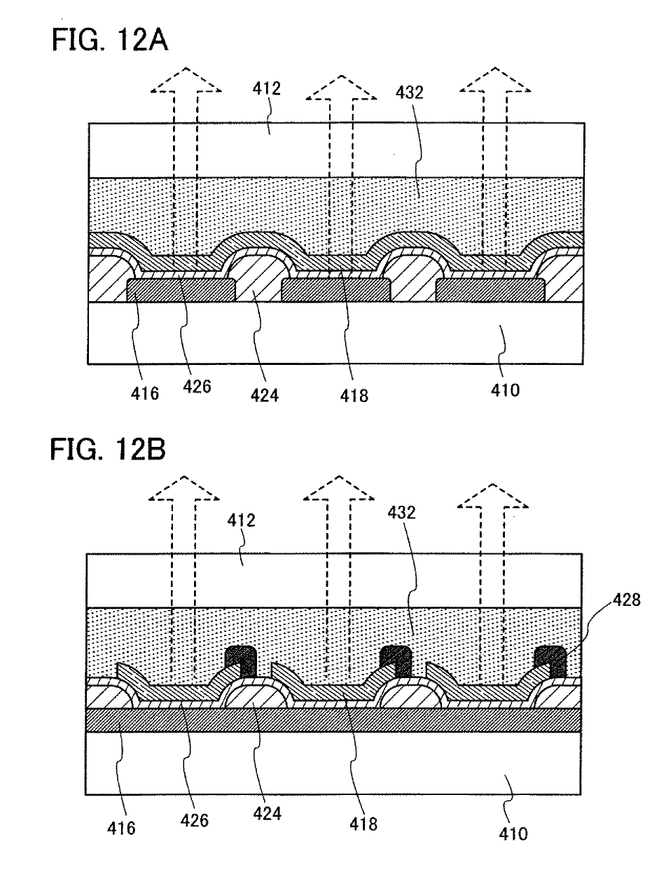

FIGS. 12A and 12B are cross-sectional diagrams taken along lines E-F and G-H in FIG. 11, respectively. FIG. 12A is the cross-sectional diagram where the first electrodes 416 in FIG. 9 are arranged. FIG. 12B is the cross-sectional view where the second electrodes 418 in FIG. 9 are arranged. The EL layer 426 is formed at the intersection of the first electrode 416 and the second electrode 418 over the substrate 410, and an EL element is formed at the intersection. As shown in FIG. 12B, the auxiliary electrode 428 is provided over the bank layer 424 so as to be in contact with the second electrode 418. When the auxiliary electrode 428 is provided over the bank layer 424, light emitted from the EL element formed at the intersection of the first electrode 416 and the second electrode 418 is not blocked, so that light emission can be effectively taken out. Further, the auxiliary electrode 428 can be prevented from being short-circuited to the first electrode 416.

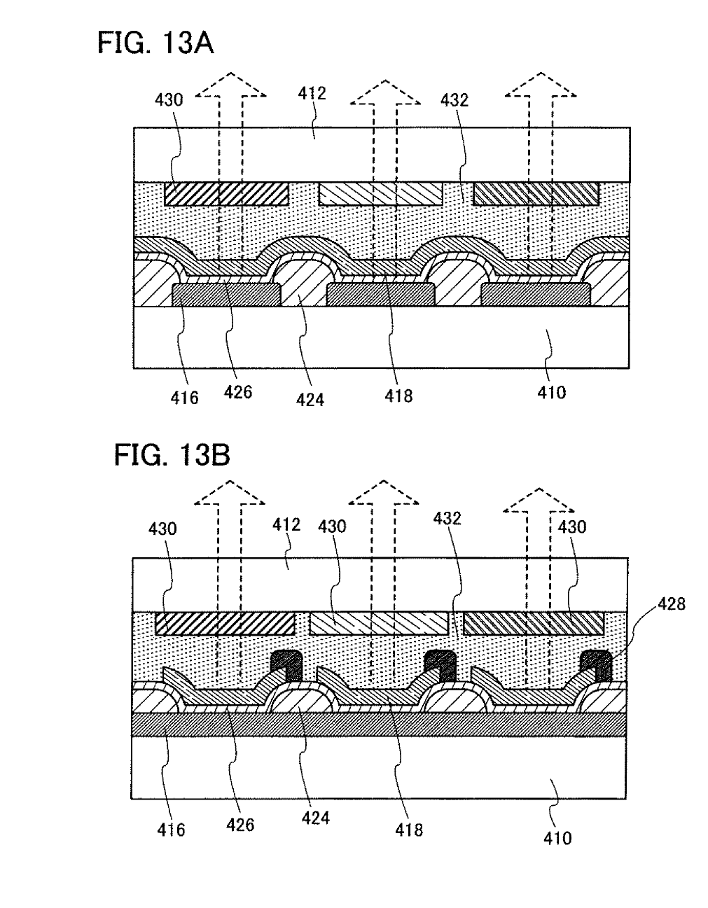

FIGS. 13A and 13B show an example where color conversion layers 430 are provided for the opposed substrate 412 of the light-emitting device shown in FIG. 9. The color conversion layers 430 each have a function of converting the wavelength of light emitted from the EL layer 426 to change the emission color. In this case, light emitted from the EL layer 426 is preferably blue light or ultraviolet light which has high energy. When color conversion layers which convert the color of light into red, green, and blue are arranged as the color conversion layers 430, a display device which performs RGB color display can be formed. Further, the color conversion layers 430 can be also replaced with colored layers (color filters). In this case, the EL layers 416 may be formed to emit white light. A filling material 432 has a function of fixing the substrate 410 and the opposed substrate 412 and may be provided as appropriate.

The light-emitting device of the present invention includes EL elements which have less variation of characteristic since defect formation process in which stress is applied externally to form a defect inside of a material is not needed, whereby a highly reliable light-emitting device can be provided.

Note that this embodiment mode can be combined with any of the other embodiment modes and embodiments as appropriate.

### Embodiment Mode 2

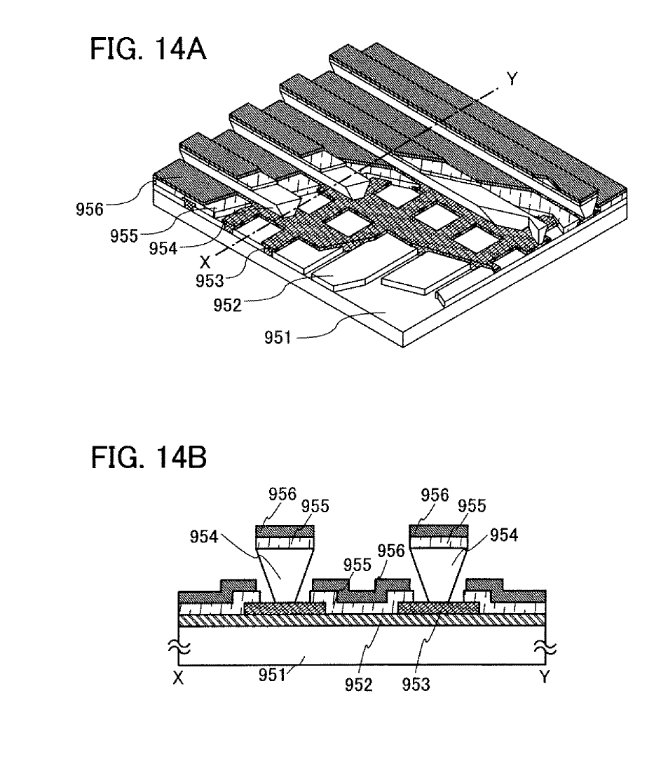

In this embodiment mode, a light-emitting device formed of EL elements having the phosphor material of the present invention is described using FIGS. 14A and 14B. The light-emitting device described in this embodiment mode is, a passive matrix light-emitting device in which EL elements are driven without a driving element such as a transistor, has a structure in which an insulating layer which covers an edge of an electrode slopes. FIG. 14A is a perspective view of such a passive matrix light-emitting device and FIG. 14B is a partial cross-sectional diagram taken along line X-Y of FIG. 14A.

In FIGS. 14A and 14B, a layer 955 is provided between an electrode 952 and an electrode 956 over a substrate 951. Note that the layer 955 includes a light-emitting layer using the phosphor material of the present invention.

An edge of the electrode 952 is covered with an insulating layer 953. A bank layer 954 is provided over the insulating layer 953. Sidewalls of the bank layer 954 have slopes so that a distance between one sidewall and the other sidewall becomes short toward a substrate surface. That is, a cross section of the bank layer 954 in the direction of a short side is trapezoidal, and a bottom base (a side expanding in the same direction as a plane direction of the insulating layer 953 and being in contact with the insulating layer 953) is shorter than a top base (a side expanding in the same direction as the plane direction of the insulating layer 953 and being not in contact with the insulating layer 953). By thus provision of the bank layer 954, a defect of an EL element due to static electricity or the like can be prevented. Further, by provision of the bank layer 954 having the shape shown in FIGS. 14A and 14B, the layer 955 and the second electrode 956 can be formed in a self-aligned manner.

An AC drive EL element which is formed over a dielectric layer formed over a electrode is described in this embodiment mode, Note that, in the case of forming a DC drive EL element, the dielectric layer does not need to be provided. Further, as for a layer containing the light-emitting layer, a stacked-layer structure of a p-type semiconductor and an n-type semiconductor may be employed. Furthermore, another layer can be provided in addition to the light-emitting layer, as the layer 955. For example, under the light-emitting layer, any of a layer for improving the orientation of the light-emitting layer or a layer which functions like an injection layer or a transport layer may be provided.

The light-emitting device of the present invention includes EL elements which have less variation of characteristic since defect formation process in which stress is applied externally to form a defect inside of a material is not needed, whereby a highly reliable light-emitting device can be provided.

Note that this embodiment mode can be combined with any of the other embodiment modes and embodiments as appropriate.

### Embodiment Mode 3

In this embodiment mode, electronic apparatuses each having the light-emitting device of the present invention are described.

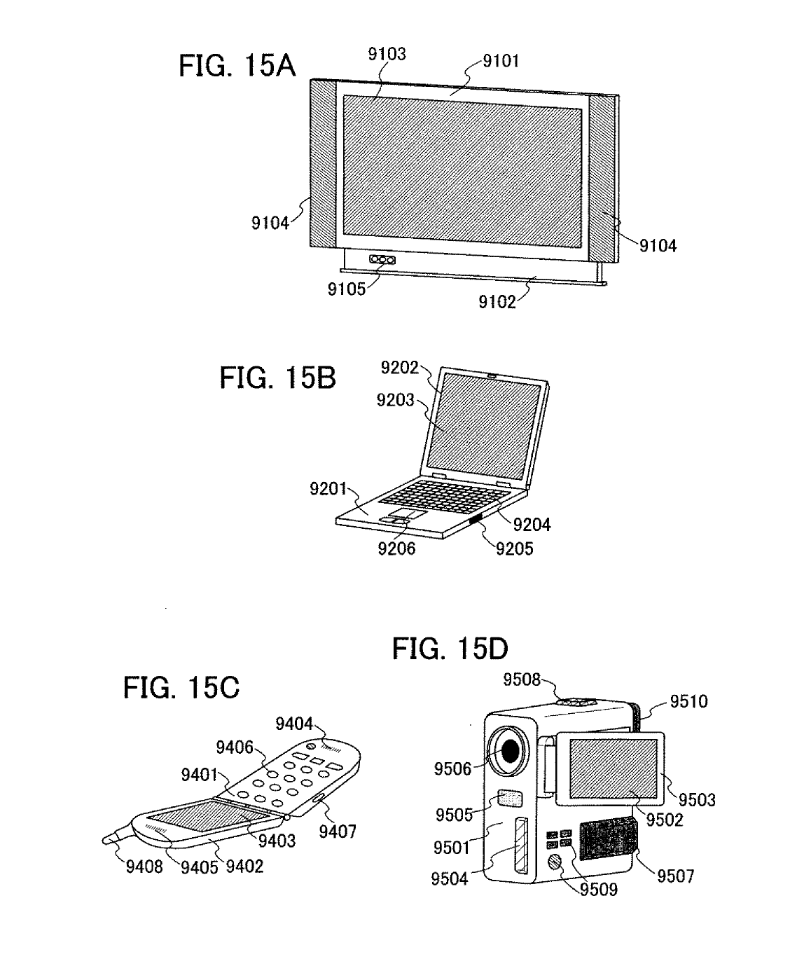

Examples of an electronic apparatus manufactured using the light-emitting device of the present invention include: cameras including video cameras and digital cameras, goggle type displays, navigation systems, audio reproducing devices (e.g., car audio component stereos and audio component stereos), computers, game machines, portable information terminals (e.g., mobile computers, mobile phones, portable game machines, and electronic books), image reproducing devices provided with recording media (specifically, a device capable of reproducing the content of a recording medium such as a digital versatile disc (DVD) and provided with a display device that can display the reproduced image), and the like. Specific examples of such an electronic apparatus are shown in FIGS. 15A to 15D.

FIG. 15A shows a television set in accordance with the present invention, which includes a housing 9101, a supporting base 9102, a display portion 9103, speaker portions 9104, video input terminals 9105, and the like. In this television set, the display portion 9103 is formed of arrangement of EL elements including the phosphor material of the present invention.

The EL element formed by the present invention has less variation of characteristic since defect formation process in which stress is applied externally to form a defect inside of a material is not needed. Therefore, the television set of the present invention has an advantage of high reliability.

FIG. 15B shows a computer in accordance with the present invention, which includes a main body 9201, a housing 9202, a display portion 9203, a keyboard 9204, an external connection port 9205, a pointing device 9206, and the like. In this computer, the display portion 9203 is formed of arrangement of EL elements including the phosphor material of the present invention.

The EL element formed by the present invention has less variation of characteristic since defect formation process in which stress is applied externally to form a defect inside of a material is not needed. Therefore, the computer of the present invention has an advantage of high reliability.

FIG. 15C shows a mobile phone in accordance with the present invention, which includes a main body 9401, a housing 9402, a display portion 9403, an audio input portion 9404, an audio output portion 9405, operation keys 9406, an external connection port 9407, an antenna 9408, and the like. In this mobile phone, the display portion 9403 is formed of arrangement of EL elements including the phosphor material of the present invention.

The EL element formed by the present invention has less variation of characteristic since defect formation process in which stress is applied externally to form a defect inside of a material is not needed. Therefore, the mobile phone of the present invention has an advantage of high reliability.

FIG. 15D shows a camera in accordance with the present invention, which includes a main body 9501, a display portion 9502, a housing 9503, an external connection port 9504, a remote controller receiving portion 9505, an image receiving portion 9506, a battery 9507, an audio input portion 9508, operation keys 9509, an eyepiece portion 9510, and the like. In this camera, the display portion 9502 is formed of arrangement of EL elements including the phosphor material of the present invention.

The EL element formed by the present invention has less variation of characteristic since defect formation process in which stress is applied externally to form a defect inside of a material is not needed. Therefore, the camera of the present invention has an advantage of high reliability.

As described above, the applicable range of the light-emitting device of the present invention is so wide that the light-emitting device can be applied to electronic apparatuses in various fields. By using the light-emitting device of the present invention, an electronic apparatus having a highly reliable display portion which has low manufacturing cost and less luminance degradation can be provided.

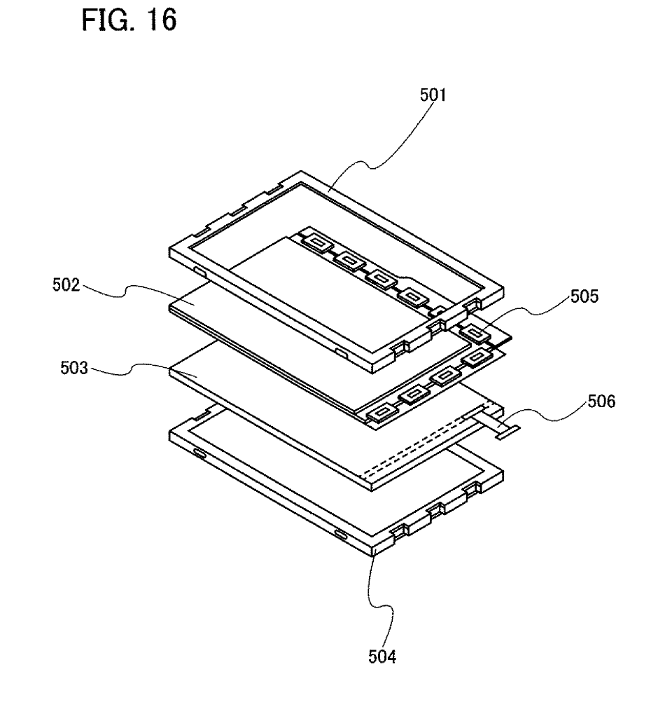

Further, since the light-emitting device of the present invention includes EL elements with high emission efficiency, it can also be used as a lighting device. One mode of using the EL element of the present invention for a lighting device is described using FIG. 16.

FIG. 16 shows an example of a liquid crystal display device which uses the light-emitting device of the present invention as a backlight. The liquid crystal display device shown in FIG. 16 includes a housing 501, a liquid crystal layer 502, a backlight 503, and a housing 504, and the liquid crystal layer 502 is connected to a driver IC 505. The light-emitting device of the present invention is used for the backlight 503, and current is supplied through a terminal 506.

By using the light-emitting device of the present invention as a backlight of a liquid crystal display device, a highly reliable backlight can be obtained. Further, the light-emitting device of the present invention has a thin shape and has low power consumption; therefore, reduction of thickness and power consumption of the whole of a liquid crystal display device can also be achieved.

### Embodiment 1

In this embodiment, one example of forming novel phosphor materials is described.

The amount of 55.9 mmol (4.551 g) of zinc oxide (ZnO) as a metal oxide, 0.414 mmol (22.74 mg) of manganese (Mn) that is a transition metal as an additive for controlling the conductivity of the metal oxide, and 55.9 mmol (5.449 g) of zinc sulfide (ZnS) as a base material were put in a planetary ball mill, and crushed for 1 hour at 300 rpm by wet process. At this time, zinc oxide and manganese formed a solid solution material. The additive amount of manganese with respect to zinc oxide was 0.74 mol %, and molar ratio of zinc oxide which has been added with manganese to zinc sulfide was 50:50. Further, manganese was mixed into zinc sulfide that is the base material so that a solid solution was formed, and also has a function as a luminescence center.

After drying, baking for 3 hours at 1300° C. was performed thereon so that a phosphor material having a eutectic structure (composite structure) was obtained. As for the baking after zinc sulfide was mixed, it is preferable to perform the baking in an atmosphere in which oxygen is removed, such as a hydrogen sulfide (H₂S) atmosphere or a nitrogen (N₂) atmosphere so that oxidation reaction does not progress. In this embodiment, the baking was performed in a nitrogen atmosphere. Further, pelletizing was performed by applying pressure at about 200 MPa at the time of the baking to form a baked pellet so that the eutectic structure was obtained easily. The baked pellet was crushed in a mortar, and then sifted with a sieve having openings of a diameter of 100 microns, with the result that a powder of the phosphor material was able to be obtained.

As described above, through the procedure in which ZnO that is the metal oxide given as an example of a conductive material, Mn that is the additive (i.e., the transition metal), and ZnS that is the base material are mixed at the same time and baked, the phosphor material having a eutectic structure (composite structure) was made. As for the phosphor material having a eutectic structure (composite structure), defect formation process in which stress is applied externally to form a defect inside of a phosphor material is not needed.

Next, an EL element was formed using the powder of the phosphor material. A dispersion liquid in which 3.3 mg of cyano resin and 100 mg of the phosphor material are dispersed into dimethylformamide (DMF) was made, applied over a glass substrate 100 provided in advance with a light-transmitting electrode 101 of ITO or the like, and was dried for 30 minutes in an oven at 120° C. so that a light-emitting layer 103 at a thickness of about 50 μm was formed.

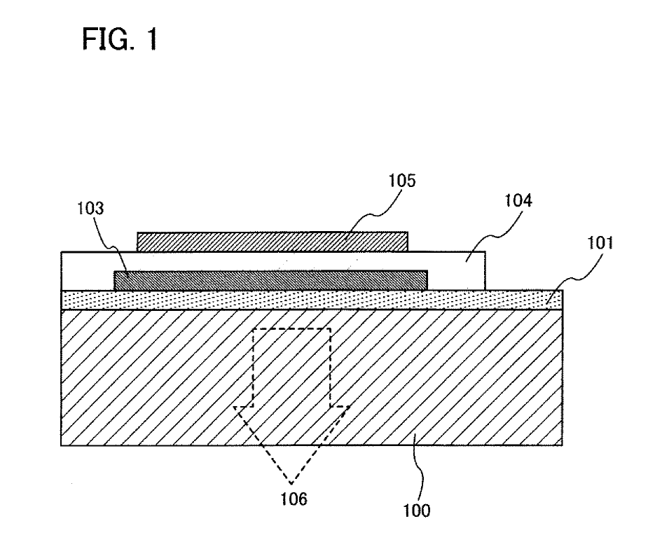

A dispersion liquid in which 1 g of cyano resin and 3 g of barium titanate are dispersed into 1.8 g of dimethylformamide (DMF) was made, and applied over the light-emitting layer. Then, drying for 60 minutes in an oven at 120° C. was performed thereon so that a dielectric layer 104 was formed. A silver paste was deposited over the dielectric layer. Then, drying for 60 minutes in an oven at 120° C. was performed thereon so that an opposed electrode 105 was formed. The opposed electrode 105 can be formed by a printing method. In this manner, the EL element was formed (FIG. 1). This EL element is a dispersion type EL element, and a light 106 is emitted through the light-transmitting electrode 101.

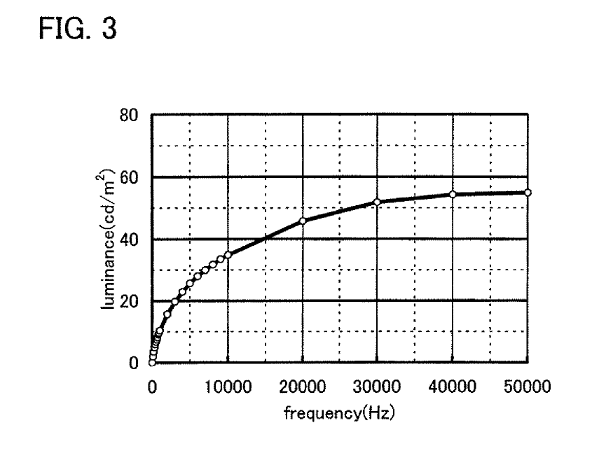

When an AC voltage of 400 V at 50000 Hz was applied to this EL element, luminescence of about 55 cd/m² was obtained (FIG. 3). Specifically, the EL properties in which the luminance increases from 0 cd/m² to 55 cd/m² nonlinearly in the frequency range of 0 Hz to 50000 Hz was obtained.

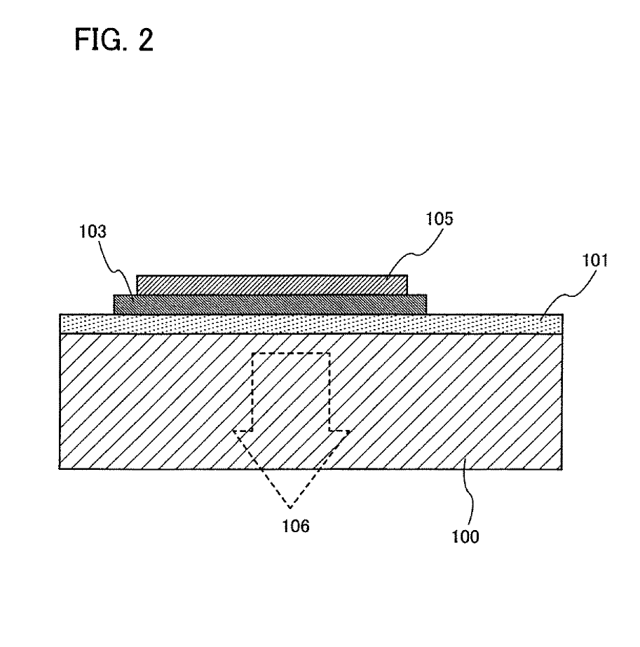

Furthermore, an EL element in which the dielectric layer was not formed but the opposed electrode 105 was directly formed over the light-emitting layer 103 made by the application of the above-described dispersion liquid of the phosphor material over the glass substrate 100 provided in advance with the light-transmitting electrode 101 of ITO or the like was made (FIG. 2). This EL element is a dispersion type EL element, and the light 106 is emitted through the light-transmitting electrode 101.

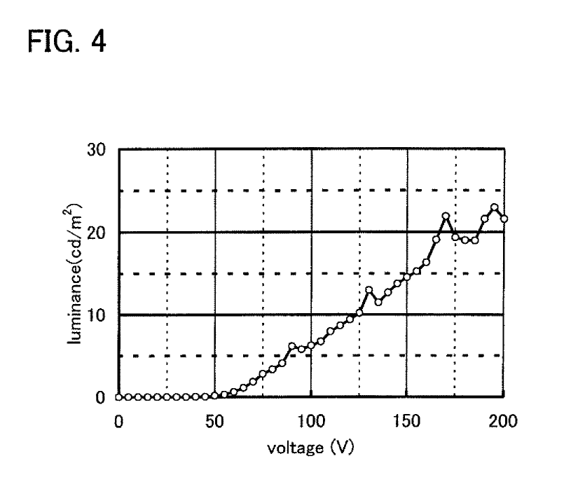

When a DC voltage was applied to this EL element, luminescence of about 20 cd/m² was obtained (FIG. 4). Specifically, EL properties in which the luminance increases from 0 cd/m² to 25 cd/m² in the voltage range of 50 V to 200 V was obtained. As described above, it was found that EL can be obtained even by DC driving according to the EL element of the present invention, though EL has been obtained only by AC driving in the case of a conventional phosphor including Mn. DC driving is superior to AC driving in no need for an inverter circuit.

With the phosphor material of the present invention, EL elements having less variation of characteristic can be manufactured since defect formation process in which stress is applied externally to form a defect inside of a phosphor material is not needed.

### Embodiment 2

Described in this embodiment is another example of forming a novel phosphor material, which is a procedure in which a solid solution material is formed first and then the solid solution material and a base material are mixed so that a phosphor material having a eutectic structure is formed, unlike Embodiment Mode 1 in which all the materials are mixed at the same time.

Zinc sulfide which has been added with manganese at 0.43 wt %, ZnS:Mn, was prepared. By the addition of manganese that is a transition metal, the zinc sulfide was activated in advance and a solid solution material was formed. The amount of 5.449 g of this solid solution (ZnS:Mn) and 4.551 g of zinc oxide (ZnO) were used and baking was performed thereon in a similar manner to that of Embodiment 1 so that a phosphor material having a eutectic structure (composite structure) was obtained. After that, through the process of crushing and sieving, a powder of the phosphor material was able to be obtained. In this embodiment also, the baking after zinc sulfide was added was performed in a nitrogen atmosphere. Further, it is preferable to pelletize at the time of the baking for obtaining the eutectic structure.

Manganese that is a transition metal was used as an additive. Manganese can be mixed with zinc sulfide in a solid solution, and further has a function as a luminescence center. The additive amount of manganese with respect to zinc oxide was 0.76 mol %, and molar ratio of zinc oxide which has been added with manganese to zinc sulfide was 50:50.

As described above, through the procedure in which a mixture in which ZnS that is a base material and Mn that is the additive (i.e., the transition metal) are mixed and baked is prepared in advance and ZnO that is a metal oxide given as an example of a conductive material is added thereto, the phosphor material having a eutectic structure (composite structure) was made. As for the phosphor material having a eutectic structure (composite structure), defect formation process in which stress is applied externally to form a defect inside of a phosphor material is not needed.

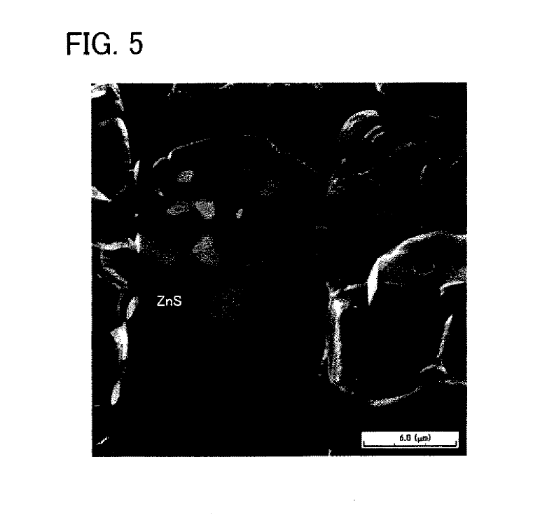

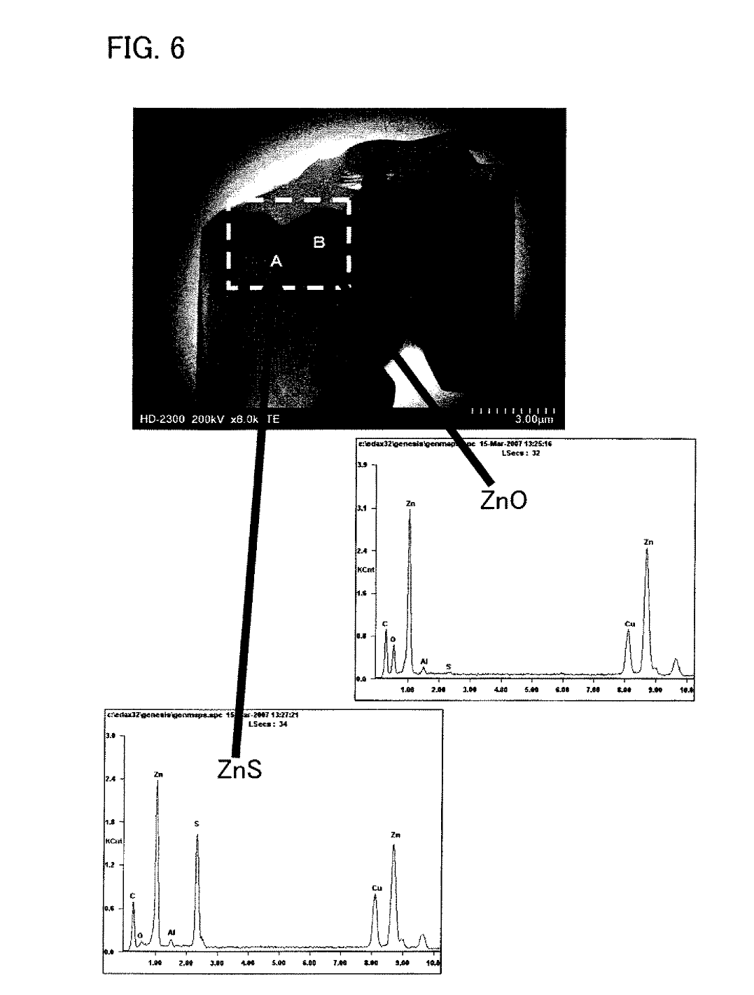

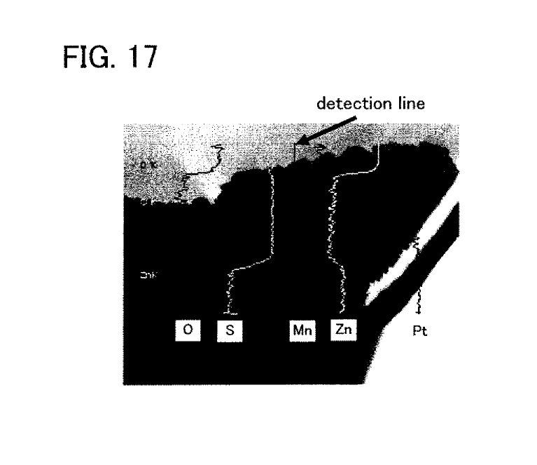

Two kinds of phases were recognized by observation of the obtained phosphor material with STEM (scanning transmission electron microscopy). By EDX (energy dispersive x-ray spectroscopy), ZnS was detected in one phase and ZnO was detected in the other phase, and it was able to be confirmed that a eutectic structure (composite structure) was formed (FIGS. 5 and 6). FIG. 5 is a SIM image at a magnification of 4000 times, from which it is found that ZnS and ZnO form a eutectic structure. FIG. 6 is a TEM image at a magnification of 7000 times, and shows EDX at point A where ZnS exists and EDX at point B where ZnO exists on the left and on the right, respectively. From the TEM image, it is found that zinc sulfide which has been added with manganese exists in the solid state in zinc oxide, and zinc oxide and zinc sulfide which has been added with manganese are segregated from each other. A TEM image and a result of EDX analysis which is superposed with the TEM image are shown in FIG. 17. It is found that Mn is detected more in the ZnS phase than in the ZnO phase.

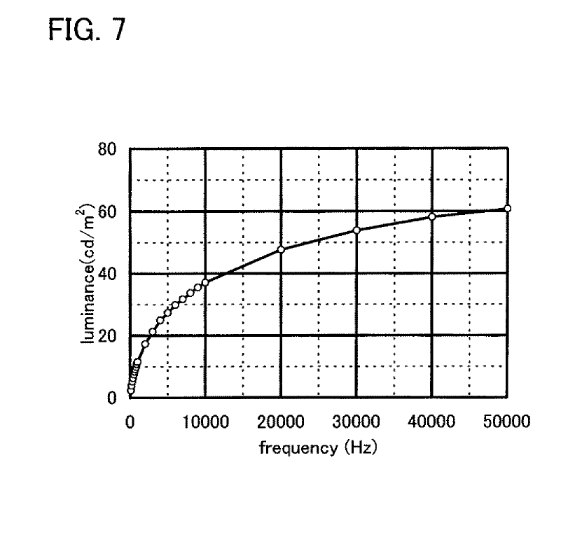

A dispersion type EL element was formed using this phosphor material in a similar manner to that of Embodiment 1. When an AC voltage of 400 V at 50000 Hz was applied to the EL element, luminescence of about 60 cd/m² was obtained (FIG. 7). Specifically, the EL properties in which the luminance increases from 0 cd/m² to 60 cd/m² nonlinearly in the frequency range of 0 Hz to 50000 Hz was obtained.

With the phosphor material of the present invention, EL elements having less variation of characteristic can be manufactured since defect formation process in which stress is applied externally to form a defect inside of a phosphor material is not needed.

### Embodiment 3

In this embodiment, another example of forming a novel phosphor material is described.

The amount of 5 g of zinc oxide (ZnO) and 0.878 g of manganese (Mn) were put in a planetary ball mill, and crushed for 1 hour at 300 rpm by wet process. The zinc oxide was used as a metal oxide and the manganese that is a transition metal was used as an additive for controlling the conductivity. After drying, baking for 3 hours at 1300° C. was performed thereon so that a solid solution of zinc oxide and manganese, ZnO:Mn, was obtained. In order tfeo obtain the solid solution easily, pelletizing was performed by applying pressure at about 200 MPa at the time of the baking.

The baked pellet was crushed in a mortar, and then, 4.551 g of the solid solution of zinc oxide and manganese, ZnO:Mn, and 5.449 g of zinc sulfide which has been activated by CuCl, ZnS:CuCl, were mixed to form a mixture. In the mixture, the manganese was also included in the zinc sulfide so that a solid solution was formed, and has a function as a luminescence center material. The additive amount of manganese with respect to zinc oxide was 26 mol %, and molar ratio of zinc oxide to zinc sulfide was 46:54. The zinc sulfide was used as a base material; and a solid solution material may be used as the base material as well.

The mixture was baked for 3 hours at 1300° C. so that a phosphor material having a eutectic structure (composite structure) was obtained. In this embodiment also, the baking after zinc sulfide was mixed was performed in a nitrogen atmosphere. Pelletizing was performed by applying pressure at about 200 MPa at the time of the baking to form a baked pellet so that the eutectic structure was obtained easily, The baked pellet was crushed again into a mortar, and then sieved with a sieve having openings having a diameter of 100 microns so that a powder of the phosphor material having a eutectic structure (composite structure) was able to be obtained.

As described above, through the procedure in which a material in which ZnO that is the metal oxide given as a conductive material and Mn that is the additive (i.e., the transition metal) are mixed and baked is prepared in advance, ZnS:CuCl that is the base material is added thereto, and baking is performed thereon to form a eutectic structure, the phosphor material having a eutectic structure (composite structure) was made. As for the phosphor material having a eutectic structure (composite structure), defect formation process in which stress is applied externally to form a defect inside of a phosphor material is not needed.

Two kinds of phases were recognized by observation of the phosphor material obtained by baking for 3 hours at 1300° C., with TEM (transmission electron microscopy). By EDX, ZnS was detected in one phase and ZnO was detected in the other phase, and it was able to be confirmed that a eutectic structure (composite structure) was formed.

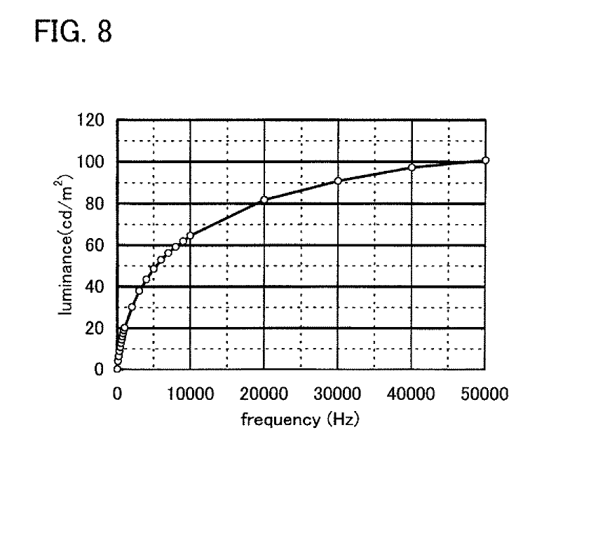

A dispersion type EL element was formed using this phosphor material in a similar manner to that of Embodiment 1. When an AC voltage of 400 V at 50000 Hz was applied to the EL element, luminescence of about 100 cd/m² was obtained (FIG. 8). Specifically, the EL properties in which the luminance increases from 0 cd/m² to 100 cd/m² nonlinearly in the frequency range of 0 Hz to 50000 Hz was obtained.

With the phosphor material of the present invention, EL elements having less variation of characteristic can be manufactured since defect formation process in which stress is applied externally to form a defect inside of a phosphor material is not needed.

### Embodiment 4

In this embodiment, another example of forming a novel phosphor material is described. Described in this embodiment is a method for manufacturing a phosphor material having an eutectic structure formed of a solid solution in which a semiconductor formed of a Group 2 element and a Group 6 element and a transition metal are mixed and a conductive material. Note that zinc sulfide, manganese, and indium oxide were used as the semiconductor formed of a Group 2 element and a Group 6 element, the transition metal, and the conductive material, respectively.

Zinc sulfide which has been added with manganese at 0.43 wt %, ZnS:Mn, was prepared. The manganese and the zinc sulfide formed a solid solution material. The amount of 2.336 g of this solid solution (ZnS:Mn) and 1.664 g of indium oxide (In₂O₃) were put in a planetary ball mill, and crushed and mixed for 1 hour at 300 rpm by wet process so that a mixture was obtained. After that, drying was performed thereon.

After drying, the mixture was baked for 3 hours at 1150° C. so that a baked material was obtained. In this embodiment also, the baking was performed in a nitrogen atmosphere after zinc sulfide was added. Further, in order to obtain the eutectic structure easily, the mixture may be pelletized at the time of the baking. After the baking, the baked material was crushed in a mortar, and then sifted with a sieve having openings of a diameter of 100 microns so that a powder of a phosphor material having a composite structure was able to be obtained.

As for the phosphor material having a eutectic structure (composite structure), defect formation process in which stress is applied externally to form a defect inside of a phosphor material is not needed.

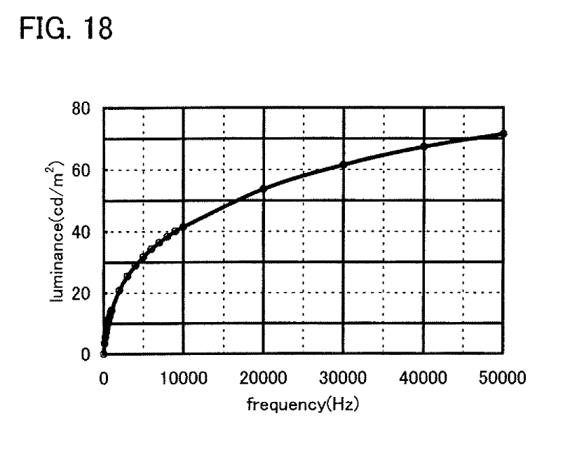

A dispersion type EL element was formed using this phosphor material in a similar manner to that of Embodiment 1. When an AC voltage of 400 V at 50000 Hz was applied to the EL element, luminescence of about 70 cd/m² was obtained (FIG. 18).

With the phosphor material of the present invention, EL elements having less variation of characteristic can be manufactured since defect formation process in which Stress is applied externally to form a defect inside of a phosphor material is not needed.

### Embodiment 5

In this embodiment, another example of forming a novel phosphor material is described. Described in this embodiment is a method for manufacturing a phosphor material having a eutectic structure formed of a first solid solution material in which a semiconductor formed of a Group 2 element and a Group 6 element and a transition metal are mixed and a second solid solution material in which a conductive material and an additive are mixed. Note that zinc sulfide, manganese, indium oxide, and tin oxide were used as the semiconductor formed of a Group 2 element and a Group 6 element, the transition metal, the conductive material, and the additive, respectively.

The amount of 7.778 g of indium oxide (In₂O₃) and 0.222 g of tin oxide (SnO₂) were put in a planetary ball mill, crushed for 1 hour at 300 rpm by wet process, and dried so that a mixture was obtained. After drying, the mixture was baked for 3 hours at 1150° C. so that a solid solution of indium tin oxide that is a solid solution material, In₂O₃:Sn, was obtained. In order to form the solid solution easily, pelletizing was performed by applying pressure at about 200 MPa at the time of the baking to form a baked pellet.

Zinc sulfide which has been activated by Mn at 0.43 wt %, ZnS:Mn, was prepared. The manganese and the zinc sulfide formed a solid solution that is a solid solution material, ZnS:Mn.

The baked pellet was crushed in a mortar, 1.664 g of the solid solution of indium tin oxide, In₂O₃:Sn, and 2.336 g of the solid solution, ZnS:Mn, were put in a planetary ball mill, and crushed and mixed for 1 hour at 300 rpm by wet process so that a mixture was obtained.

The mixture was baked for 3 hours at 1150° C. so that a phosphor material having a eutectic structure (composite structure) was obtained. In this embodiment also, the baking was performed in a nitrogen atmosphere after zinc sulfide was added. Further, the mixture was pelletized at the time of the baking to form the baked pellet so that the eutectic structure was obtained easily. The baked pellet was crushed in a mortar, and then sifted with a sieve having openings of a diameter of 100 microns so that a powder of the phosphor material having a composite structure was able to be obtained.

As for the phosphor material having a eutectic structure (composite structure), defect formation process in which stress is applied externally to form a defect inside of a phosphor material is not needed.

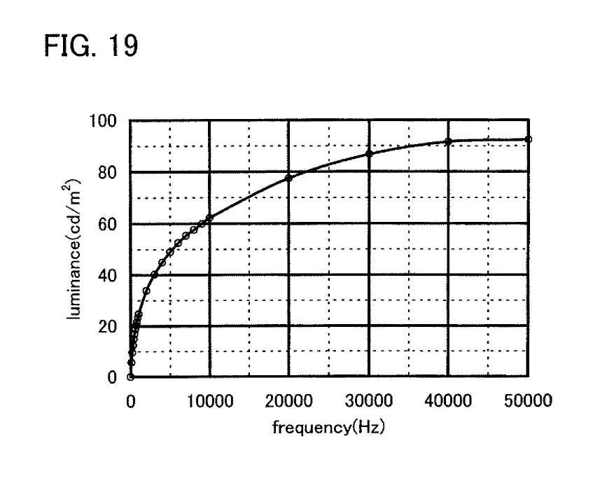

A dispersion type EL element was formed using this phosphor material in a similar manner to that of Embodiment 1. When an AC voltage of 400 V at 50000 Hz was applied to the EL element, luminescence of about 92 cd/m² was obtained (FIG. 19).

With the phosphor material of the present invention, EL elements having less variation of characteristic can be manufactured since defect formation process in which stress is applied externally to form a defect inside of a phosphor material is not needed.

### Embodiment 6

In this embodiment, another example of forming a novel phosphor material is described. In this embodiment, magnesium oxide was used as an additive unlike Embodiment 5.

The amount of 2.977 g of indium oxide (In₂O₃) and 0.023 g of magnesium oxide (MgO) were put in a planetary ball mill, crushed for 1 hour at 300 rpm by wet process, and dried so that a mixture was obtained. After drying, the mixture was baked for 3 hours at 1150° C. so that a solid solution of indium magnesium oxide that is a solid solution material, In₂O₃:Mg, was obtained. Pelletizing was performed by applying pressure at about 200 MPa at the time of the baking to form a baked pellet so that the solid solution was formed easily.

Zinc sulfide which has been activated by Mn at 0.43 wt %, ZnS:Mn, was prepared. The manganese and the zinc sulfide formed a solid solution that is a solid solution material, ZnS:Mn.

The baked pellet was crushed in a mortar, 1.664 g of the solid solution of indium magnesium oxide, In₂O₃:Mg, and 2.336 g of the solid solution, ZnS:Mn, were put in a planetary ball mill, and crushed and mixed for 1 hour at 300 rpm by wet process so that a mixture was obtained.

The mixture was baked for 3 hours at 1150° C. so that a phosphor material having a eutectic structure (composite structure) was obtained. In this embodiment also, the baking was performed in a nitrogen atmosphere after zinc sulfide was added. Further, the mixture was pelletized at the time of the baking to form the baked pellet so that the eutectic structure was obtained easily. The baked pellet was crushed in a mortar, and then sifted with a sieve having openings of a diameter of 100 microns so that a powder of the phosphor material having a composite structure was able to be obtained.

As for the phosphor material having a eutectic structure (composite structure), defect formation process in which stress is applied externally to form a defect inside of a phosphor material is not needed.

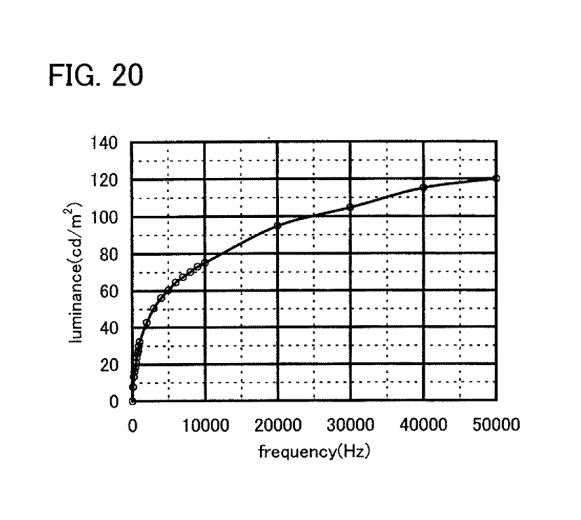

A dispersion type EL element was formed using this phosphor material in a similar manner to that of Embodiment 1. When an AC voltage of 400 V at 50000 Hz was applied to the EL element, luminescence of about 120 cd/m² was obtained (FIG. 20).

With the phosphor material of the present invention, EL elements having less variation of characteristic can be manufactured since defect formation process in which stress is applied externally to form a defect inside of a phosphor material is not needed.

### Embodiment 7

In this embodiment, another example of forming a novel phosphor material is described. In this embodiment, zinc oxide and gallium oxide were used as a conductive material and an additive, respectively, unlike Embodiment 5.

The amount of 7.135 g of zinc oxide (ZnO) and 0.865 g of gallium oxide (Ga₂O₃) were put in a planetary ball mill, crushed for 1 hour at 300 rpm by wet process, and dried so that a mixture was obtained. After drying, the mixture was baked for 3 hours at 1150° C. so that a solid solution of zinc gallium oxide that is a solid solution material, ZnO:Ga, was obtained. Pelletizing was performed by applying pressure at about 200 MPa at the time of the baking to form a baked pellet so that the solid solution was obtained easily.

Zinc sulfide which has been activated by Mn at 0.43 wt %, ZnS:Mn, was prepared. The manganese and the zinc sulfide formed a solid solution that is a solid solution material, ZnS:Mn.

The baked pellet was crushed in a mortar, 1.821 g of the solid solution of zinc gallium oxide, ZnO:Ga, and 2.179 g of the solid solution, ZnS:Mn, were put in a planetary ball mill, and crushed and mixed for 1 hour at 300 rpm by wet process so that a mixture was obtained.

The mixture was baked for 3 hours at 1150° C. so that a phosphor material having a eutectic structure (composite structure) was obtained. In this embodiment also, the baking after zinc sulfide was added was performed in a nitrogen atmosphere. Further, the mixture was pelletized at the time of the baking to form the baked pellet so that the eutectic structure was obtained easily. The baked pellet was crushed in a mortar, and then sifted with a sieve having openings of a diameter of 100 microns so that a powder of the phosphor material having a composite structure was able to be obtained.

As for the phosphor material having a eutectic structure (composite structure), defect formation process in which stress is applied externally to form a defect inside of a phosphor material is not needed.

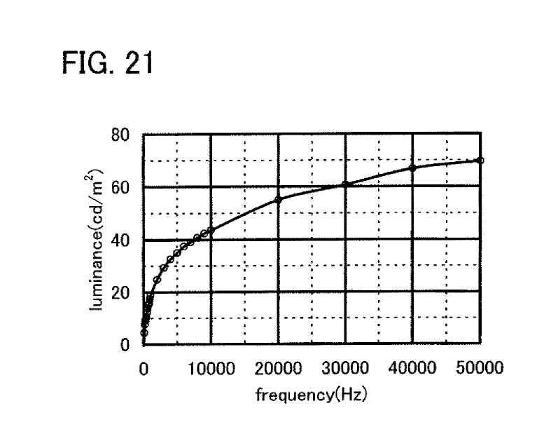

A dispersion type EL element was formed using this phosphor material in a similar manner to that of Embodiment 1. When an AC voltage of 400 V at 50000 Hz was applied to the EL element, luminescence of about 70 cd/m² was obtained (FIG. 21).

With the phosphor material of the present invention, EL elements having less variation of characteristic can be manufactured since defect formation process in which stress is applied externally to form a defect inside of a phosphor material is not needed.

### Embodiment 8

In this embodiment, another example of forming a novel phosphor material is described. In this embodiment, zinc oxide and aluminum oxide were used as a conductive material and an additive, respectively, unlike Embodiment 5.

The amount of 7.505 g of zinc oxide (ZnO) and 0.495 g of aluminum oxide (Al₂O₃) were put in a planetary ball mill, crushed for 1 hour at 300 rpm by wet process, and dried so that a mixture was obtained. After drying, the mixture was baked for 3 hours at 1150° C. so that a solid solution of zinc aluminum oxide that is a solid solution material, ZnO:Al, was obtained. Pelletizing was performed by applying pressure at about 200 MPa at the time of the baking to form a baked pellet so that the solid solution was formed easily.

Zinc sulfide which has been activated by Mn at 0.43 wt %, ZnS:Mn, was prepared. The manganese and the zinc sulfide formed a solid solution that is a solid solution material, ZnS:Mn.

The baked pellet was crushed in a mortar, 1.821 g of the solid solution of zinc aluminum oxides ZnO:Al, and 2.179 g of the solid solution, ZnS:Mn, were put in a planetary ball mill, and crushed and mixed for 1 hour at 300 rpm by wet process so that a mixture was obtained.

The mixture was baked for 3 hours at 1150° C. so that a phosphor material having a eutectic structure (composite structure) was obtained. In this embodiment also, the baking after zinc sulfide was added was performed in a nitrogen atmosphere. Further, the mixture was pelletized at the time of the baking to form the baked pellet so that the eutectic structure was obtained easily. The baked pellet was crushed in a mortar, and then sifted with a sieve having openings of a diameter of 100 microns so that a powder of the phosphor material having a composite structure was able to be obtained.

As for the phosphor material having a eutectic structure (composite structure), defect formation process in which stress is applied externally to form a defect inside of a phosphor material is not needed.

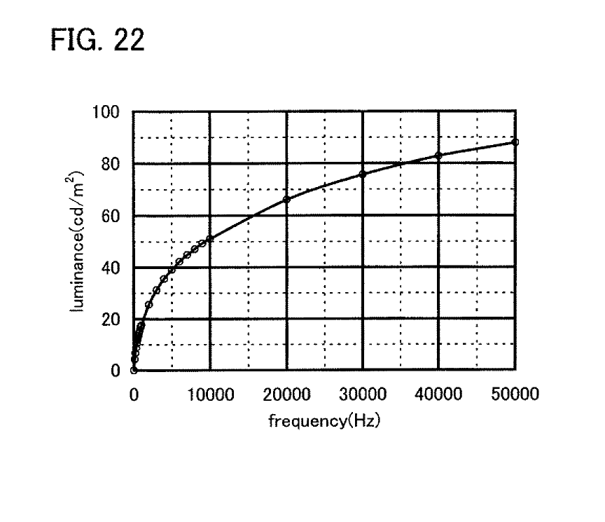

A dispersion type EL element was formed using this phosphor material in a similar manner to that of Embodiment 1. When an AC voltage of 400 V at 50000 Hz was applied to the EL element, luminescence of about 88 cd/m² was obtained (FIG. 22).

With the phosphor material of the present invention, EL elements having less variation of characteristic can be manufactured since defect formation process in which stress is applied externally to form a defect inside of a phosphor material is not needed.

### Embodiment 9

In this embodiment, another example of forming a novel phosphor material is described. In this embodiment, zinc oxide and iridium oxide were used as a conductive material and an additive, respectively, unlike Embodiment 5.

The amount of 2.443 g of zinc oxide (ZnO) and 0.557 g of iridium oxide (IrO₂) were put in a planetary ball mill, crushed for 1 hour at 300 rpm by wet process, and dried so that a mixture was obtained. After drying, the mixture was baked for 3 hours at 1150° C. so that a solid solution of zinc iridium oxide that is a solid solution material, ZnO:Ir, was obtained. Pelletizing was performed by applying pressure at about 200 MPa at the time of the baking to form a baked pellet so that the solid solution was formed easily.

Zinc sulfide which has been activated by Mn at 0.43 wt %, ZnS:Mn, was prepared. The manganese and the zinc sulfide formed a solid solution that is a solid solution material, ZnS:Mn.

The baked pellet was crushed in a mortar, 1.821 g of the solid solution of zinc iridium oxide, ZnO:Ir, and 2.179 g of the solid solution, ZnS:Mn, were put in a planetary ball mill, and crushed and mixed for 1 hour at 300 rpm by wet process so that a mixture was obtained.

The mixture was baked for 3 hours at 1150° C. so that a phosphor material having a eutectic structure (composite structure) was obtained. In this embodiment also, the baking after zinc sulfide was added was performed in a nitrogen atmosphere. Further, the mixture was pelletized at the time of the baking to form the baked pellet so that the eutectic structure was obtained easily. The baked pellet was crushed in a mortar, and then sifted with a sieve having openings of a diameter of 100 microns so that a powder of the phosphor material having a composite structure was able to be obtained.

As for the phosphor material having a eutectic structure (composite structure), defect formation process in which stress is applied externally to form a defect inside of a phosphor material is not needed.

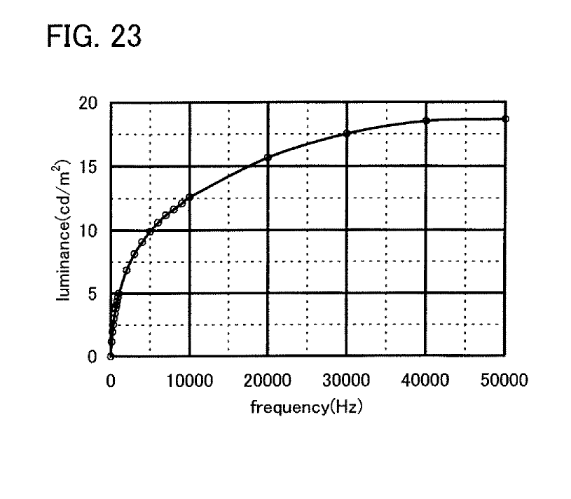

A dispersion type EL element was formed using this phosphor material in a similar manner to that of Embodiment 1. When an AC voltage of 400 V at 50000 Hz was applied to the EL element, luminescence of about 18.6 cd/m² was obtained (FIG. 23).

With the phosphor material of the present invention, EL elements having less variation of characteristic can be manufactured since defect formation process in which stress is applied externally to form a defect inside of a phosphor material is not needed.

### Embodiment 10

In this embodiment, another example of forming a novel phosphor material is described. In this embodiment, molybdenum oxide was used as a conductive material unlike Embodiment 4.

Zinc sulfide which has been added with manganese at 0.43 wt %, ZnS:Mn, was prepared. The manganese and the zinc sulfide formed a solid solution material. The amount of 2.618 g of this solid solution, ZnS:Mn, and 0.382 g of molybdenum oxide (MoO₂) were put in a planetary ball mill, and crushed and mixed for 1 hour at 300 rpm by wet process so that a mixture was obtained. After that, drying was performed thereon.

After drying, the mixture was baked for 3 hours at 1150° C. so that a baked material was obtained. In this embodiment also, the baking after zinc sulfide was added was performed in a nitrogen atmosphere. Further, in order to obtain the eutectic structure easily, the mixture may be pelletized at the time of the baking. After the baking, the baked material was crushed in a mortar, and then sifted with a sieve having openings of a diameter of 100 microns so that a powder of a phosphor material having a composite structure was able to be obtained.

As for the phosphor material having a eutectic structure (composite structure), defect formation process in which stress is applied externally to form a defect inside of a phosphor material is not needed.

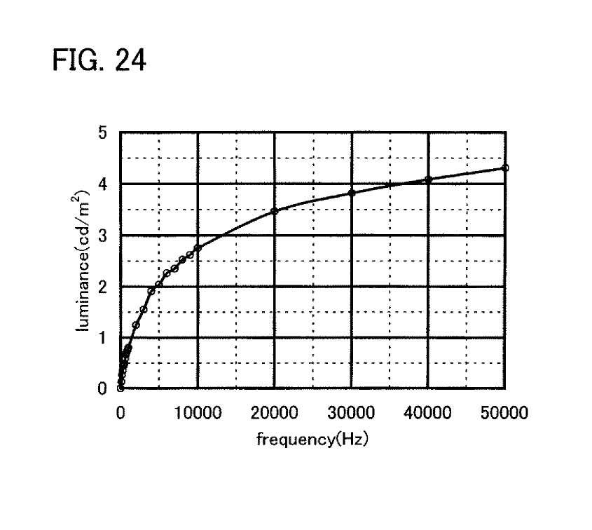

A dispersion type EL element was formed using this phosphor material in a similar manner to that of Embodiment 1. When an AC voltage of 400 V at 50000 Hz was applied to the EL element, luminescence of about 4.3 cd/m² was obtained (FIG. 24).

With the phosphor material of the present invention, EL elements having less variation of characteristic can be manufactured since defect formation process in which stress is applied externally to form a defect inside of a phosphor material is not needed.

### Embodiment 11

In this embodiment, another example of forming a novel phosphor material is described. In this embodiment, iridium oxide was used as a conductive material unlike Embodiment 4.

Zinc sulfide which has been added with manganese at 0.43 wt %, ZnS:Mn, was prepared. The manganese and the zinc sulfide formed a solid solution material. The amount of 2.389 g of this solid solution, ZnS:Mn, and 0.611 g of iridium oxide (IrO₂) were put in a planetary ball mill, and crushed and mixed for 1 hour at 300 rpm by wet process so that a mixture was obtained. After that, drying was performed thereon.

After drying, the mixture was baked for 3 hours at 1150° C. so that a baked material was obtained. In this embodiment also, the baking after zinc sulfide was added was performed in a nitrogen atmosphere. Further, in order to obtain the eutectic structure easily, the mixture may be pelletized at the time of the baking. After the baking, the baked material was crushed in a mortar, and then sifted with a sieve having openings of a diameter of 100 microns so that a powder of a phosphor material having a composite structure was able to be obtained.

As for the phosphor material having a eutectic structure (composite structure), defect formation process in which stress is applied externally to form a defect inside of a phosphor material is not needed.

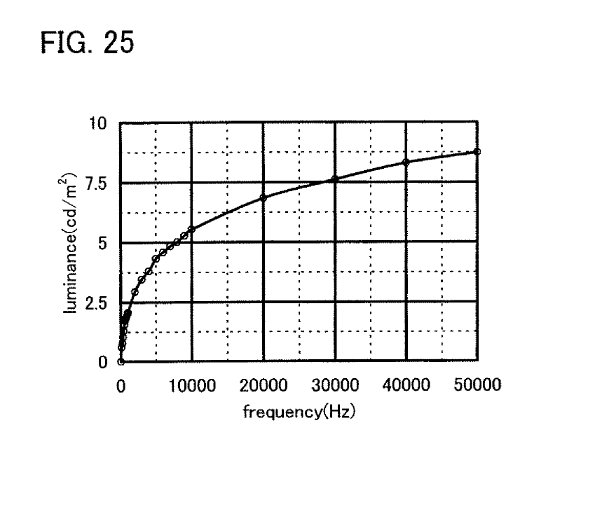

A dispersion type EL element was formed using this phosphor material in a similar manner to that of Embodiment 1. When an AC voltage of 400 V at 50000 Hz was applied to the EL element, luminescence of about 8.7 cd/m² was obtained (FIG. 25).

With the phosphor material of the present invention, EL elements having less variation of characteristic can be manufactured since defect formation process in which stress is applied externally to form a defect inside of a phosphor material is not needed.

### Embodiment 12

In this embodiment, another example of forming a novel phosphor material is described. Described in this embodiment is a method for manufacturing a phosphor material having a eutectic structure formed of a solid solution material in which a semiconductor formed of a Group 2 element and a Group 6 element and a transition metal are mixed and a semiconductor formed of a Group 3 element and a Group 5. Note that zinc sulfide, manganese, and indium phosphide were used as the semiconductor formed of a Group 2 element and a Group 6 element the transition metal, and the semiconductor formed of a Group 3 element and a Group 5 element, respectively.

Zinc sulfide which has been added with manganese at 0.43 wt %, ZnS:Mn, was prepared. The manganese and the zinc sulfide formed a solid solution material. The amount of 2.911 g of this solid solution, ZnS:Mn, and 1.089 g of indium phosphide (InP) were put in a planetary ball mill, and crushed and mixed for 1 hour at 300 rpm by wet process so that a mixture was obtained. After that, drying was performed thereon.

After drying, the mixture was baked for 3 hours at 1150° C. so that a baked material was obtained. In this embodiment also, the baking after zinc sulfide was added was performed in a nitrogen atmosphere. Further, in order to obtain the eutectic structure easily, the mixture may be pelletized at the time of the baking. After the baking, the baked material was crushed in a mortar, and then sifted with a sieve having openings of a diameter of 100 microns so that a powder of a phosphor material having a composite structure was able to be obtained.

As for the phosphor material having a eutectic structure (composite structure), defect formation process in which stress is applied externally to form a defect inside of a phosphor material is not needed.

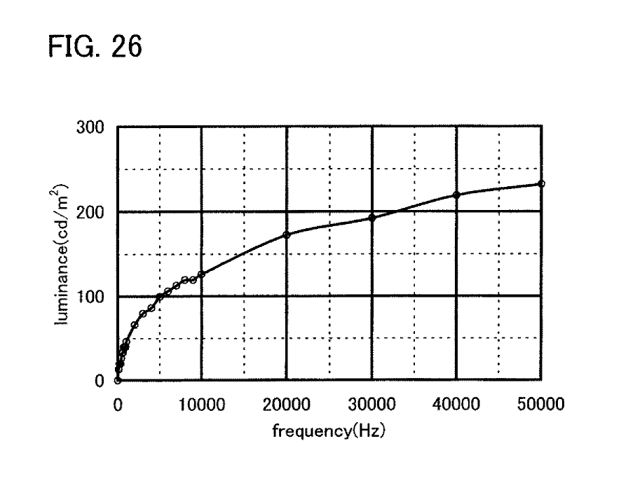

A dispersion type EL element was formed using this phosphor material in a similar manner to that of Embodiment 1. When an AC voltage of 400 V at 50000 Hz was applied to the EL element, luminescence of about 232 cd/m² was obtained (FIG. 26).

With the phosphor material of the present invention, EL elements having less variation of characteristic can be manufactured since defect formation process in which stress is applied externally to form a defect inside of a phosphor material is not needed.

This application is based on Japanese Patent Application Serial No. 2007080203 filed with Japan Patent Office on Mar. 26, 2007, the entire contents of which are hereby incorporated by reference.

What is claimed is:

1. A phosphor material comprising:
a semiconductor which is formed of a Group 2 element and a Group 6 element; and
a material,
wherein the semiconductor and the material forms a eutectic structure.

2. A phosphor material according to claim 1,
wherein the material forms a semiconductor which is formed of a Group 2 element and a Group 6 element.

3. A phosphor material according to claim 1,
wherein the material forms a semiconductor which is formed of a Group 3 element and a Group 5 element.

4. A phosphor material according to claim 1,
wherein the material forms an alkaline earth metal.

5. A phosphor material according to claim 1,
wherein the material forms a ternary material which is formed of a Group 3 element or a Group 6 element.

6. A phosphor material comprising:
a conductive material; and
a material,
wherein the conductive material and the material form a eutectic structure.

7. A phosphor material according to claim 6,
wherein the material forms a semiconductor which is formed of a Group 2 element and a Group 6 element.

8. A phosphor material according to claim 6,
wherein the material forms a semiconductor which is formed of a Group 3 element and a Group 5 element.

9. A phosphor material according to claim 6,
wherein the material forms an alkaline earth metal.

10. A phosphor material according to claim 6,
wherein the material forms a ternary material which is formed of a Group 3 element or a Group 6 element.

11. A phosphor material according to claim 1, further comprising a solid solution material mixed with a transition metal.

12. A phosphor material according to claim 6, further comprising a solid solution material mixed with a transition metal.

13. A phosphor material according to claim 11,
wherein the material and the solution material are segregated from each other.

14. A phosphor material according to claim 12,
wherein the material and the solution material are segregated from each other.

15. The phosphor material according to claim 6,
wherein the conductive material is a metal oxide, and the metal oxide is any one of zinc oxide (ZnO), nickel oxide (NiO), tin oxide (SnO₂), titanium oxide (TiO₂), cobalt trioxide (CoO₃), cobalt oxide (CoO), tungsten oxide (WO₃), molybdenum oxide (MoO₃), vanadium trioxide (V₂O₃), vanadium pentoxide (V₂O₅), indium tin oxide (ITO), indium oxide (In₂O₃), rhenium trioxide (ReO₃), ruthenium oxide (RuO₂), strontium ruthenium oxide (SrRuO₃), strontium iridium oxide (SrIrO₃), and barium lead oxide (BaPbO₃).

16. The phosphor material according to claim 11, wherein the solid solution material includes the transition metal at a rate which is equal to or more than 0.01 mol % and equal to or less than 100 mol % with respect to the material.

17. The phosphor material according to claim 12, wherein the solid solution material includes the transition metal at a rate which is equal to or more than 0.01 mol % and equal to or less than 100 mol % with respect to the material.

18. The phosphor material according to claim 11, wherein the transition metal is any one of manganese (Mn), copper (Cu), and chromium (Cr).

19. The phosphor material according to claim 12, wherein the transition metal is any one of manganese (Mn), copper (Cu), and chromium (Cr).

20. The phosphor material according to claim 11, wherein a molar ratio of the solid solution material to the material is equal to or more than 0.1 and equal to or less than 100.

21. The phosphor material according to claim 12, wherein a molar ratio of the solid solution material to the material is equal to or more than 0.1 and equal to or less than 100.

22. The phosphor material according to claim 11, wherein a molar ratio of the solid solution material to the material is equal to or more than 0.3 and equal to or less than 3.

23. The phosphor material according to claim 12, wherein a molar ratio of the solid solution material to the material is equal to or more than 0.3 and equal to or less than 3.

24. The phosphor material according to claim 11, wherein a grain diameter of the solid solution material is smaller than that of the material.

25. The phosphor material according to claim 12, wherein a grain diameter of the solid solution material is smaller than that of the material.

26. The phosphor material according to claim 11, wherein a grain diameter of the solid solution material is equal to or less than ½ of the material.

27. The phosphor material according to claim 12, wherein a grain diameter of the solid solution material is equal to or less than ½ of the material.

28. The phosphor material according to claim 1, wherein the material is any one of cadmium sulfide (CdS), cadmium selenide (CdSe), cadmium telluride (CdTe), zinc sulfide (ZnS), zinc selenide (ZnSe), zinc telluride (ZnTe), calcium sulfide (CaS), magnesium sulfide (MgS), strontium sulfide (SrS), gallium phosphide (GaP), and gallium arsenide (GaAs).

29. The phosphor material according to claim 6, wherein the material is any one of cadmium sulfide (CdS), cadmium selenide (CdSe), cadmium telluride (CdTe), zinc sulfide (ZnS), zinc selenide (ZnSe), zinc telluride (ZnTe), calcium sulfide (CaS), magnesium sulfide (MgS), strontium sulfide (SrS), gallium phosphide (GaP), and gallium arsenide (GaAs).

30. A phosphor material comprising:
a semiconductor which is formed of a Group 2 element and a Group 6 element;
a solution material mixed with a transition metal; and
a material,
wherein the semiconductor, the solution material and the material form a eutectic structure.

31. A phosphor material according to claim 30,
wherein the material is a conductive material.

32. A phosphor material according to claim 30,
wherein the material is a solution material mixed with a conductive material and an additive.

33. A phosphor material according to claim 30,
wherein the material is a semiconductor which is formed of a Group 3 element and a Group 5 element.

34. A phosphor material according to claim 30,
wherein the transition metal is any one of manganese (Mn), copper (Cu), and chromium (Cr).

35. A method for manufacturing a phosphor material, comprising:
mixing either a semiconductor formed of a Group 2 element and a Group 6 element or a conductive material and a transition metal with each other and then baking; and
adding any one of a semiconductor which is formed of a Group 2 element and a Group 6 element, a semiconductor which is formed of a Group 3 element and a Group 5 element, an alkaline earth metal, and a ternary material which is formed of a Group 3 element or a Group 6 element to a baked material obtained by the baking and then baking, so that a eutectic structure is formed.

36. A method for manufacturing a phosphor material, comprising:
mixing any one of a semiconductor which is formed of a Group 2 element and a Group 6 element, a semiconductor which is formed of a Group 3 element and a Group 5 element, an alkaline earth metal, and a ternary material which is formed of a Group 3 element or a Group 6 element and a transition metal with each other and then baking; and
adding either a semiconductor formed of a Group 2 element and a Group 6 element or a conductive material to a baked material obtained by the baking and then baking, so that a eutectic structure is formed.

37. A method for manufacturing a phosphor material, comprising:
mixing either a semiconductor formed of a Group 2 element and a Group 6 element or a conductive material, one of a semiconductor which is formed of a Group 2 element and a Group 6 element, a semiconductor which is formed of a Group 3 element and a Group 5 element, an alkaline earth metal, and a ternary material which is formed of a Group 3 element or a Group 6 element to transition metal and then baking so that a eutectic structure is formed.

38. A method for manufacturing a phosphor material according to claim 35,
wherein a grain diameter of either the semiconductor formed of a Group 2 element and a Group 6 element or the conductive material which is mixed is equal to or more than 0.01 μm and equal to or less than 1 μm.

39. A method for manufacturing a phosphor material according to claim 36,
wherein a grain diameter of either the semiconductor formed of a Group 2 element and a Group 6 element or the conductive material which is mixed is equal to or more than 0.01 μm and equal to or less than 1 μm.

40. A method for manufacturing a phosphor material according to claim 37,
wherein a grain diameter of either the semiconductor formed of a Group 2 element and a Group 6 element or the conductive material which is mixed is equal to or more than 0.01 μm and equal to or less than 1 μm.
